(19) United States
(12) Patent Application Publication
(10) Pub. No.: US 2016/0219124 A1
(43) Pub. Date: Jul. 28, 2016

(54) METHOD FOR PROMOTING SOCIAL CONNECTIVITY`

(71) Applicant: YOAV ELGRICHI, SINGAPORE (SG)

(72) Inventor: YOAV ELGRICHI, SINGAPORE (SG)

(21) Appl. No.: 14/722,042

(22) Filed: May 26, 2015

Related U.S. Application Data
(60) Provisional application No. 62/107,419, filed on Jan. 25, 2015.

(51) Int. Cl. H04L 29/08

(52) U.S. Cl. CPC H04L 67/306

(57) ABSTRACT

A method enabling socializing of users wearing wearable electronic devices. The method includes a mechanism to set manually or automatically a visible indication on the wearable device interface that indicates the willingness status of a user to the surrounding. The colored indication can start manually by the user or started automatically by the proximity of the watch or the other wearable device, to another relevant device. The subject method or application may be used for a dating aid for meeting others, or to create social opportunities.

### CROSS REFERENCE TO RELATED APPLICATIONS

This application claims priority under 35 U.S.C. & 119(e) to U.S. Provisional Patent Application No. 62/107,419 entitled SYSTEM FOR PROMOTING SOCIAL CONNECTIVITY, filed on Jan. 25, 2015.

### FIELD OF THE INVENTION

The present invention relates to wearable devices capable of providing visual indication and more particularly, to wearable devices capable of providing visual indication for promoting social connectivity.

### BACKGROUND OF THE INVENTION

Social networking involves forming connections between individuals and/or organizations. The development of online social networks touches countless aspects of our everyday lives, providing instant access to people of similar mindsets, and enabling the formation of partnerships with more people in more ways than even before.

Proximity-based social networking applications are applications that use geo-proximity as a selection filter in determining who is discoverable on the social network.

Technologies that are in use today to enable devices to discover other devices over short distances are Wi-Fi, ad-hoc Wi-Fi, BLUETOOTH®, ZIGBEE® and NFC (Near Field Communications), so the devices should be compliant with any one or more of such wireless technologies.

The term “NEC compliant device” refers to a wireless communication device that is compliant with at least one of the ISO specifications including ISO 14443A, ISO 14443B, ISO 18092, and ISO 15693.

The term “Ad-Hoc Wi-Fi compliant device” refers to a wireless communication device that is compliant with the ad-hoc mode being part of the 802.11 standard from the Institute of Electronic and Electrical Engineers (IEEE).

The term “BLUETOOTH® compliant device” refers to a wireless communication device that is compliant with the Bluetooth standard as specified by the Bluetooth Special Interest Group (SIG).

The term “ZIGBEE® compliant device” refers to a wireless communication device that is compliant with 802.15.4 standard from the Institute of Electronic and Electrical Engineers (IEEE).

### SUMMARY OF THE INVENTION

A system of the invention is intended to be used in short range interconnecting the dating and the human interaction domain, as an example, where girls/boys can indicate their intensions as regards socializing. A girl can see a visible indication on a wearable, communication ready device on a boy.

The system of the present invention can also find use in other social events such as professional conventions and seminars, where a visual feature can distinguish between buyers and vendors for example, or between visitors and investors.

### BRIEF DESCRIPTION OF THE DRAWINGS

The present invention will be understood and appreciated more fully from the following detailed description taken in conjunction with the appended drawing in which:

FIG. 1 shows one embodiment of a use case illustrating use of the indications related to the social and dating world.

FIG. 2 shows one embodiment of a wearable device that may be included in a system implementing the invention.

FIG. 3 illustrates a flow diagram showing an example of the main actions performed by the method of the present invention in accordance with one embodiment.

The following detailed description of embodiments of the invention refers to the accompanying drawing referred to above. Dimensions of components and features shown in the figures are chosen for convenience or clarity of presentation and are not necessarily shown to scale.

### DETAILED DESCRIPTION OF THE INVENTION

The present invention will be described more fully hereinafter with reference to the accompanying drawings, which show by way of illustration, specific exemplary embodiments by which the invention may be practiced. This invention may, however, be embodied in many different forms and should not be construed as limited to the embodiments set forth herein.

A major reason for people not approaching strangers in public places is the fear of rejection. The method of the present invention allows the users to indicate their willingness to socialize and at the same time give indication as to their social preference without having to actually approach a potential partner, and by so, meetings can be accomplished between people relaying on cues rather than on preparatory discussions.

The indications are colored graphic symbols displayed on the selected dedicated wearable devices. This indication may be invoked manually by the wearer to indicate his/her willingness status to the surrounding or automatically when a proximity of the wearable device to another matching device. The graphic interface may be configured remotely or manually.

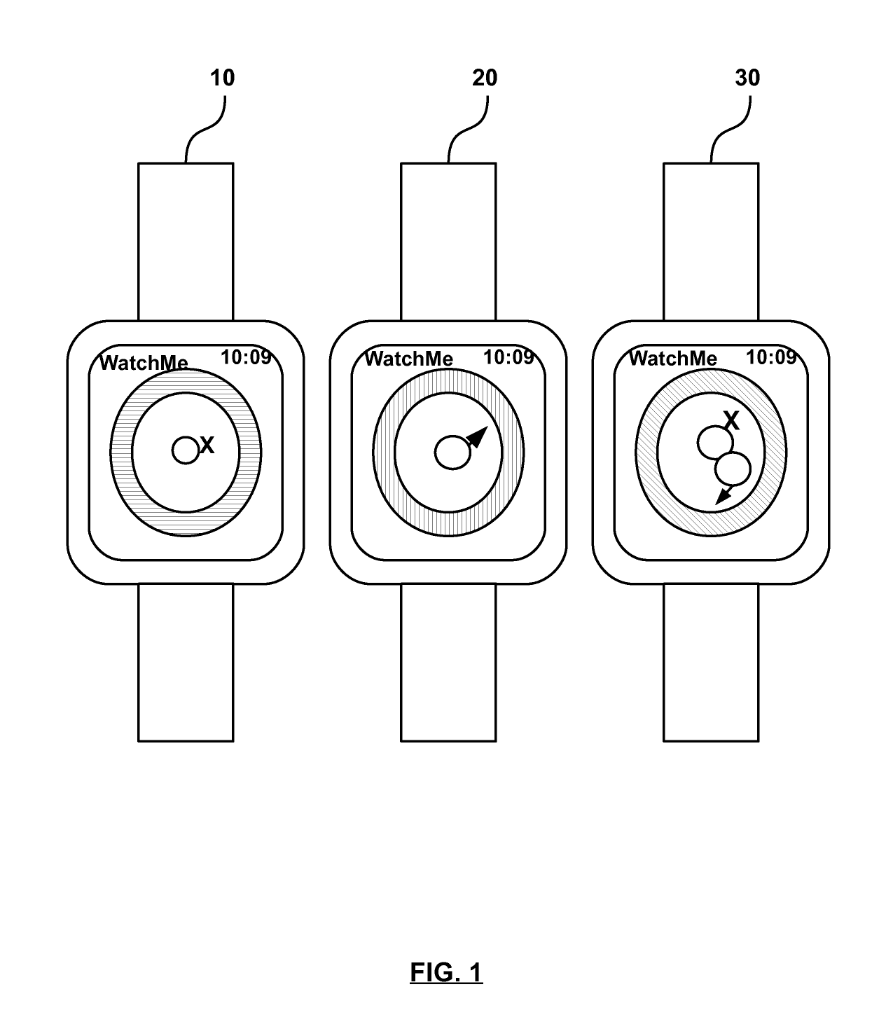

In one embodiment, the wearable devices as shown in FIG. 1 are smart watches (10, 20, and 30) which may provide indication potentially to social preference of the wearer—in this case, related to social encounters and matching with potential mates. The indication means “Girls looking for boys” in smart watch 10, “Boys looking for girls” in smart watch 20 and “Looking for same gender” in smart watch 30. In another aspect, by the demonstration of a specific color indication the user shares with his surrounding his/her willingness status in order to encourage social interaction. Thus, a girl can see the relevant color or glow on the smart watch of a boy. At this point she knows the potential partner is available and is looking to be approached by a girl.

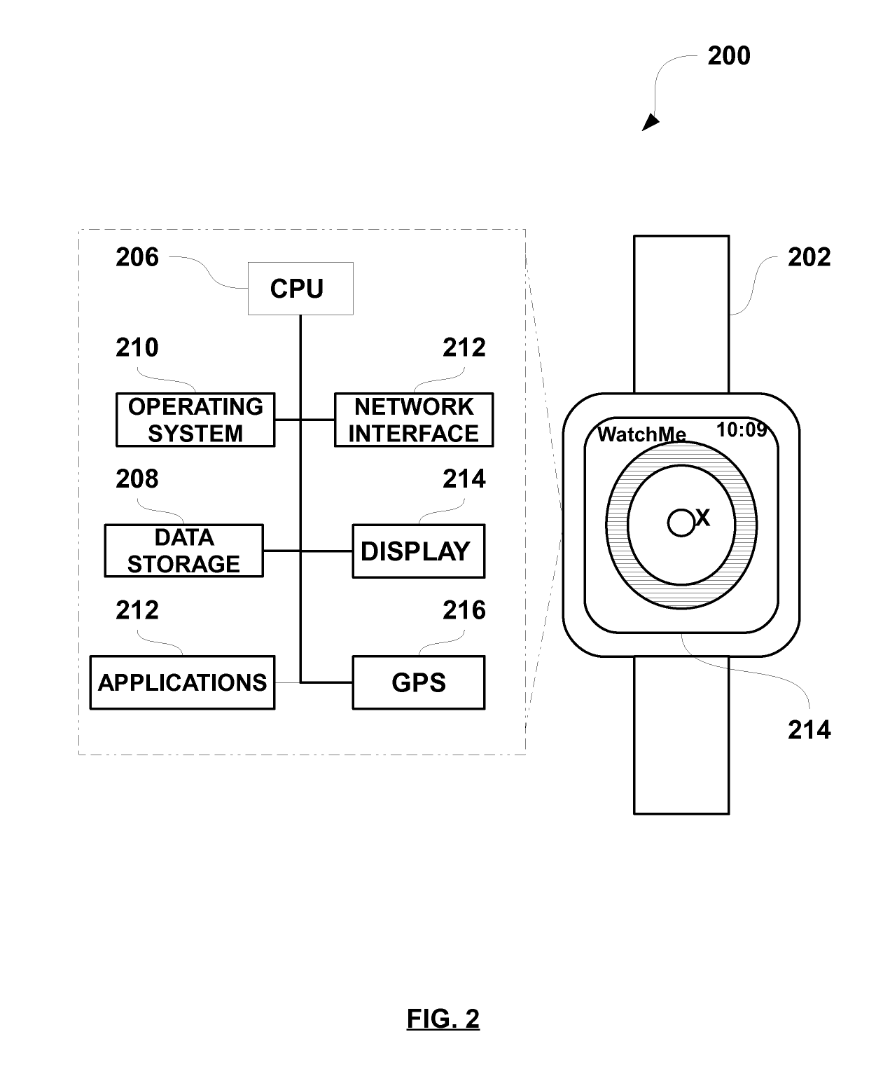

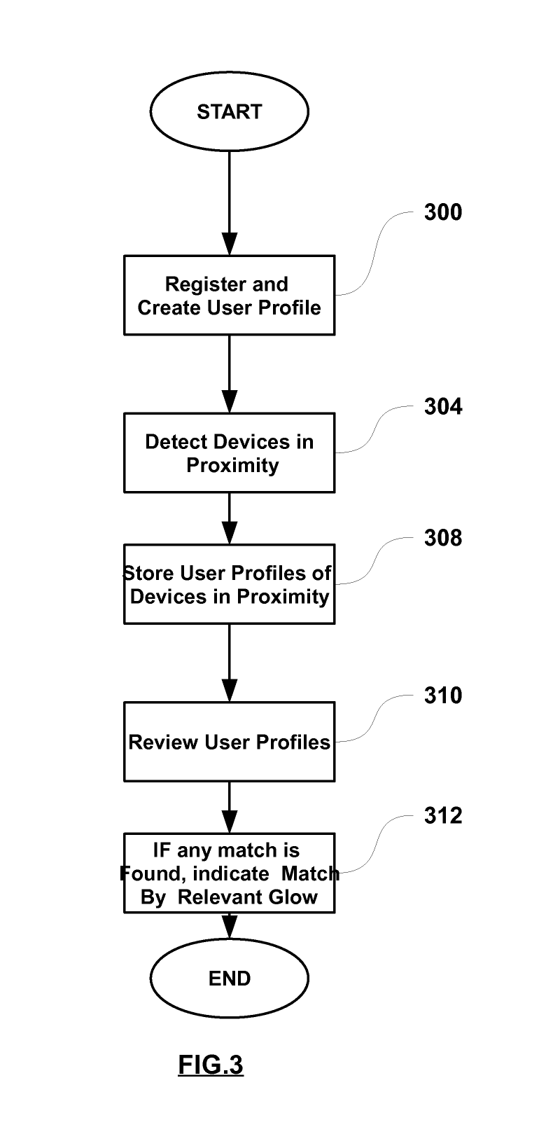

One embodiment of the present invention uses wearable devices 10-30, described in more detail below in conjunction with FIG. 2, showing the automatic implementation for bringing about interconnecting. Wearable device 200 includes a strap 202 to be worn on a hand. The device may include more components than those shown in FIG. 2. The device includes a processing unit (CPU) 206 in communication with a data storage device 208, an operating system 210, one or more network interfaces 212, display 214, one or more applications 212 including at least an application implementing the method of the present invention which is detailed at FIG. 3 and an optional global positioning system (GPS) receiver 216. The network interface includes circuitry for coupling the wearable device to one or more networks, using one or more communication protocols and technologies including but not limited to Wi-Fi, ad-hoc Wi-Fi, BLUETOOTH®, ZIGBEE® and NFC. The display may be a traditional transflective LCD or an organic light-emitting diode (OLED) display or any type of display used with a wearable device to provide an image in a field of vision.

Generalized in FIG. 3, the major tasks performed by the automatic implementation are described. At step 300, the wearer creates user profiles and the application registers the user to receive the notifications as described later. A user may create one or more profiles (e.g., work, social, sports, dating, politics) to participate in different contexts of social networking, which are then translated to requests to participate in indicated social networking, so that only users having a particular selected profile are provided with proximity-based information about the user. For example, in a dating scenario, the user populates information in a user profile, e.g. his/her willingness status to the surrounding such as “girls looking for boys”, “boys looking for girls”, “looking for same gender” and contact information. The configuration of the user profiles may be part of the download and installation process of the application.

At step 304, once the wireless communication is initialized, wearable devices in proximity are discovered using one of the methods such as those disclosed in U.S. Pat. No. 8,769,003 or in patent application US2014/0162687. U.S. Pat. No. 8,769,003 discloses a method of determining device proximity without sharing location information. The method can include receiving, by a server system, from the first and second device, identifications of an access point that both the first and the second device detect. The method can further include determining, at a proximity component of the server system for comparing the received identifications, that each of the first and second devices detect the access point. The method can also provide for transmitting to at least one of the first or second device, at the server system, a proximity indicator indicating that the first and second devices are proximal. Additional embodiments are disclosed. Patent application US2014/0162687 discloses in an embodiment, techniques to support proximity services without network support. Broadcast signals sent by a first device may be directly received by the second device and if the received signal exceeds certain threshold device, the devices are considered to be proximal. Additional embodiments are described, requiring support of the network and optionally a Global Positioning system (GPS) component in the device.

The user-supplied profiles are received through the network and are stored at the wearer device at step 308; the stored user profiles are then reviewed locally at the device at step 310 and if any match (e.g. “girls looking for boys”, and “boys looking for girls” are a match), the appropriate color indication is displayed on the wearable device as per step 112. Matching algorithms can use the profile to match members who are deemed compatible, by matching people's interests (e.g. girls looking for boys”, “boys looking for girls”).

In other embodiments, the present invention may compare any number of user-supplied profiles at a data center or another centralized location remote from the users of the devices, determine which users are matches for one another in that they appear to have one or more commonalities or other reasons for interacting, and transmit to each wearer information for the other wearers determined to be matches for the wearer.

In another embodiment of the present invention, the graphic indication is invoked once the wearer selects manually a specific profile.

The method is not limited to use in dating scenarios but is also aimed by any other social events such as professional conventions and seminars, where the color indication can distinguish between buyers and vendors, or between visitors and investors.

What is claimed is:

1. A method using wearable devices worn respectively by at least two users, for promoting social connectivity, wherein each user has an accessible, updatable user profile, said method comprising:
sending from the wearable device of a first user, a request to form a social connection based on said user profile of said first user;
receiving from the wearable device of at least a second user, a request to participate in a social connection based on said second user profile;
verifying that said first wearable device and said at least second wearable device are in proximity;
calculating a match between said request of first user and said request of at least second user; and
sending an instruction to said wearable devices whose match has been detected to issue a graphic indication announcing that a social opportunity exists.

2. A method using wearable devices worn respectively by at least one user, for promoting social connectivity, wherein each one of said at least user has an accessible updatable user profile, said method comprising:
invoking a request to participate in social activities based on user selection; and
issuing a graphic indication announcing that a social opportunity exists.
